(19) United States
(12) Patent Application Publication
(10) Pub. No.: US 2019/0325438 A1
(43) Pub. Date: Oct. 24, 2019

(54) SYSTEM AND METHOD FOR COMPLETING A TRANSACTION INITIATED AT A PAYMENT TERMINAL

(71) Applicant: Mastercard International Incorporated, Purchase, NY (US)

(72) Inventors: Ravinder Wadhwa, Pune (IN); Piyush Sharma, Pune (IN); Navneet Jain, Pune (IN)

(73) Assignee: Mastercard International Incorporated, Purchase, NY (US)

(21) Appl. No.: 16/298,130

(22) Filed: Mar. 11, 2019

(30) Foreign Application Priority Data
Apr. 20, 2018 (SG) 10201803347Y

(51) Int. Cl. G06Q 20/40; G06Q 20/02

(52) U.S. Cl. CPC G06Q 20/40; G06Q 20/027

(57) ABSTRACT

A system and method for completing a transaction initiated at a payment terminal are provided. The method comprises receiving, from the payment terminal, transaction data relating to the transaction, the transaction data including account details identifying an account and an issuer managing the account; determining if the issuer corresponds to the same entity in response to the receipt of the transaction data; and forwarding, to a payment network server, an approval message that is received from an issuer server corresponding to the issuer when it is determined that the issuer corresponds to the same entity, the approval message approving the transaction.

### CROSS REFERENCE TO RELATED APPLICATIONS

This application claims priority to Singaporean Application Serial No. 10201803347Y, filed Apr. 20, 2018, which is incorporated herein by reference in its entirety

### TECHNICAL FIELD

The present invention relates broadly, but not exclusively, to systems and methods for completing a transaction initiated at a payment terminal.

### BACKGROUND

Current financial transactions generally involve an issuer, an acquirer and a payment network facilitator. The issuer typically refers to a bank that offers branded payment cards directly to users while the acquirer is a bank or financial institution that processes credit or debit payments on behalf of a merchant. In the case where the payment method is a credit card, the issuer extends a line of credit to the user and liability for non-payment is typically shared by the issuer and the acquirer. A payment network facilitator, which manages a payment network server, offers online services to merchants for facilitating electronic payments by a variety of payment methods including credit cards, bank-based payments such as direct debit, bank transfer, and real-time bank transfer based on online banking. The payment network facilitator typically sets and administers the rules of the payment network.

Global Collection Only (GCO) refers to a data collection program in which a user (typically an acquirer) provides collection-only reporting of transactions effected with a Card, Access Device, or Account issued by the payment network facilitator. An ON_US transaction refers to a transaction for which the issuer and acquirer are managed by the same entity, i.e. the acquirer bank and the issuer bank are the same and it is not necessary to involve the payment network facilitator's facilitation to obtain an approval of funds for a transaction. In other words, ON_US transactions are acquired, processed and then approved by the same entity. For example, a user has an account in bank A and uses the account to initiate a transaction with a merchant having an account with an acquirer. In this example, the acquirer is also bank A. In this scenario, the transaction may be routed to the acquirer and to the issuer without sending the transaction data to the payment network facilitator.

More specifically, for an ON_US transaction initiated at a payment terminal, e.g. an Automated Teller Machine (ATM) or a Point-of-Sale terminal (POS), the transaction does not reach the payment network facilitator. Instead, the transaction is stored at the acquirer as a Transaction log file (a file including transaction records) and later extracted to generate Integrated Product Message (IPM) clearing files for the merchant. The IPM format is an International Organization of Standardization-based flexible format, consisting of bitmapped messages that do not require fixed-fields where data are placed.

Generally, transaction details in the ON_US transaction are not transmitted to the payment network server (or payment network facilitator) and a mismatch between the transactions reported by the acquirer (or issuer) and the actual transactions may occur. Further, merchants that are involved in the ON_US transaction typically do not invest in infrastructure, such as processing systems or clearing systems, in order to send the transaction details to the payment network server. Thus, the payment network facilitators are excluded from such transactions.

Reporting of GCO (ON_US) transactions is important to payment network facilitators so that the transaction details can be included for billing and reporting. Even though GCO is mandatory and has been applied by certain payment network facilitators, the migration to GCO is still not happening for many transactions.

A need therefore exists to provide methods for completing a transaction initiated at a payment terminal that addresses one or more of the above problems, so that the compliance to GCO may be consistent among various entities.

Furthermore, other desirable features and characteristics will become apparent from the subsequent detailed description and the appended claims, taken in conjunction with the accompanying drawings and this background of the disclosure.

### SUMMARY

According to a first aspect of the present invention, there is provided a system, comprising an acquirer server and a payment terminal, for completing a transaction initiated at the payment terminal, the acquirer server and the payment terminal being managed by a same entity, the acquirer server comprising: at least one processor; and at least one memory including computer program code; the at least one memory and the computer program code configured to, with the at least one processor, cause the acquirer server at least to: receive, from the payment terminal, transaction data relating to the transaction, the transaction data including account details identifying an account and an issuer managing the account; determine if the issuer corresponds to the same entity in response to the receipt of the transaction data; and forward, to a payment network server, an approval message that is received from an issuer server corresponding to the issuer when it is determined that the issuer corresponds to the same entity, the approval message approving the transaction.

In an embodiment, the approval message may be forwarded to the payment network server via a switch that is located between the acquirer server and the issuer server, the acquirer server forwards the approval message to the payment network server via the switch, and the acquirer server may be further caused to: generate an identification message when it is determined that the issuer corresponds to the same entity managing the acquirer server and the payment terminal, the identification message identifying the transaction; include, in the transaction data, an acquirer identifier identifying the acquirer; and transmit, to the switch, the identification message to cause the switch to include an indicator to the approval message after receiving the approval message from the issuer server, the indicator indicating that the approval message relates a transaction to the issuer being the same entity managing the acquirer server and the payment terminal.

In an embodiment, the acquirer server may be further caused to: receive, from the switch, an acknowledgement message indicating a successful transmission of the approval message to the payment network server; generate a transaction completion message in response to the acknowledgement message to indicate the successful completion of the transaction, the transmission completion message being generated in response to a successful transfer of funds to an acquirer account included in the transaction data; and transmit, to the payment terminal, the transaction completion message.

In an embodiment, the acquirer server may be further caused to control the switch to include the indicator to the approval message.

In an embodiment, the acquirer server may be further caused to control the switch to transmit the acknowledgement message.

According to a second aspect of the present invention, there is provided a device for completing a transaction initiated at the payment terminal, the device comprising: at least one processor; and at least one memory including computer program code; the at least one memory and the computer program code is further configured with the at least one processor, cause the device at least to: receive, from an issuer server, an approval message corresponding to an issuer; include an indicator in the approval message, the indicator indicating that the approval message relates to a transaction to the issuer being the same entity managing an acquirer server and a payment terminal; and add the approval message corresponding to the issuer to a list, the list listing the approval message corresponding to the issuer who has generated the approval message.

In an embodiment, the device may be further caused to: generate a plurality of data packets; and generate and transmit a request message to a payment network server for transmitting the approval message during a trickle feed session, the trickle feed session being a time period during which the device provides the plurality of data packets to the payment network server.

In an embodiment, the device may be further caused to: receive, from the payment network server, an acknowledgement message indicating a successful transmission of the approval message; and forward, to an acquirer server, the acknowledgement message, the acquirer server corresponding to an acquirer.

In an embodiment, the approval message may comprise an issuer identifier identifying the issuer and the device may be further caused to: receive, from the acquirer server, a plurality of identification messages, each of the plurality of identification message comprising a corresponding acquirer identifier identifying the acquirer; verify data in the list and data in the plurality of identification messages based on the acquirer identifier and the issuer identifier, such that the data in the list corresponds to the data in the plurality of identification messages; transmit, to the payment network server, the list via the trickle feed session at a predetermined period of time after a successful verification of the data in the list and the data in the plurality of identification messages.

In an embodiment, the device may be further caused to: generate and transmit a list request message to the payment network server for transmitting the list; receive, from the payment network server, a list acknowledgement message indicating a successful transmission of the list.

According to a third aspect of the present invention, there is provided a computer-implemented method for completing a transaction initiated at a payment terminal, the acquirer server and the payment terminal being managed by a same entity, the method comprising: receiving, from the payment terminal, transaction data relating to the transaction, the transaction data including account details identifying an account and an issuer managing the account; determining if the issuer corresponds to the same entity in response to the receipt of the transaction data; and forwarding, to a payment network server, an approval message that is received from an issuer server corresponding to the issuer when it is determined that the issuer corresponds to the same entity, the approval message approving the transaction.

In an embodiment, the method may further comprise generating an identification message when it is determined that the issuer corresponds to the same entity managing the acquirer server and the payment terminal, the identification message identifying the transaction; including, in the transaction data, an acquirer identifier identifying the acquirer; and transmitting, to the switch, the identification message to cause the switch to include an indicator to the approval message after receiving the approval message from the issuer server, the indicator indicating that the approval message relates a transaction to the issuer being the same entity managing the acquirer server and the payment terminal.

In an embodiment, the method may further comprise receiving, from the switch, an acknowledgement message indicating a successful transmission of the approval message to the payment network server; generating a transaction completion message in response to the acknowledgement message to indicate the successful completion of the transaction, the transmission completion message being generated in response to a successful transfer of funds to an acquirer account included in the transaction data; and transmitting, to the payment terminal, the transaction completion message.

In an embodiment, the method may further comprise controlling the switch to include the indicator to the approval message.

In an embodiment, the method may further comprise controlling the switch to transmit the acknowledgement message.

In an embodiment, the method may further comprise receiving, from the issuer server, the approval message corresponding to the issuer; including the indicator in the approval message, the indicator indicating that the approval message relates a transaction to the issuer being the same entity managing the acquirer server and the payment terminal; and adding, to a list, the approval message corresponding to the issuer, the list listing the approval message corresponding to the issuer who has generated the approval message.

In an embodiment, the method may further comprise generating a plurality of data packets; and generating and transmitting a request message to the payment network server for transmitting the approval message during a trickle feed session, the trickle feed session being a time period during which a device provides the plurality of data packets to the payment network server.

In an embodiment, the method may further comprise receiving, from the payment network server, an acknowledgement message indicating a successful transmission of the approval message; and forwarding, to the acquirer server, the acknowledgement message.

In an embodiment, the method may further comprise receiving a plurality of identification messages from the acquirer server, each of the plurality of identification message comprising a corresponding acquirer identifier identifying the acquirer; verifying data in the list and data in the plurality of identification messages based on the acquirer identifier and the issuer identifier, such that the data in the list corresponds to the data in the plurality of identification messages; transmitting, to the payment network server, the list via the trickle feed session at a predetermined period of time after a successful verification of the data in the list and the data in the plurality of identification messages.

In an embodiment, the method may further comprise generating and transmitting a list request message to the payment network server for transmitting the list; receiving, from the payment network server, a list acknowledgement message indicating a successful transmission of the list.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram of a system 100 within which a transaction can be completed at a payment terminal according to an example embodiment.

FIGS. 2a to 2b show a flow chart 200 illustrating the flow of information during a method for completing a transaction initiated at a payment terminal according to an example embodiment.

FIG. 2c shows a flow chart 255 illustrating the flow of information from an acquirer server perspective during a method for completing a transaction initiated at a payment terminal according to an example embodiment.

FIG. 3 shows a schematic diagram 300 illustrating the flow of information between various entities during a method for completing a transaction initiated at a payment terminal, according to an example embodiment.

FIG. 4 shows a schematic diagram 400 illustrating the flow of information between a trickle feed generator and a payment network server during a method for completing a transaction initiated at a payment terminal, according to an example embodiment.

FIG. 5 shows a schematic diagram 500 illustrating the flow of information between various entities during a method for completing a transaction initiated at a payment terminal, according to an example embodiment.

FIG. 6 shows a schematic diagram 600 illustrating the request and response between various entities during a method for completing a transaction initiated at a payment terminal, according to an example embodiment

FIG. 7 shows a schematic diagram of a computer system 700 suitable for use in executing the method depicted in FIGS. 2a to 2b.

FIG. 8 shows an exemplary computing device to realize a server for the acquirer server 102 shown in FIG. 1.

FIG. 9 shows an exemplary computing device to realize a switch 112 shown in FIG. 1.

### DETAILED DESCRIPTION

### Overview

Various embodiments of the present disclosure provide a device, a method and a system that completes a transaction initiated at a payment terminal, more specifically notifying a payment network server of a transaction when the payment terminal, acquirer, issuer are managed by the same entity.

A user (or consumer) purchases a product from a merchant at his store or website and uses his account (e.g., a card and/or digital wallet) to initiate a transaction at a payment terminal of the merchant. The transaction request includes transaction data including price of the product and the user's account details. The account (card and/or digital wallet) may be managed by an issuer having a corresponding issuer server while the payment terminal may be managed by an acquirer having a corresponding acquirer server. The transaction data may also include an acquirer identifier identifying the acquirer and an issuer identifier identifying the issuer. When the account (card and/or digital wallet) is used at the payment terminal, the acquirer server receives the transaction data and determines, from the acquirer identifier and the issuer identifier in the transaction data, that the issuer and the acquirer are the same entity. As the acquirer and the issuer are the same entity, the acquirer server routes the transaction to the issuer server, which determines if there are sufficient funds in the user's account for purchase of the product.

If there are sufficient funds in the user's account, the issuer server transmits, to the acquirer server, an approval message approving the transaction. The approval message may include the transaction details, the user's account details corresponding to user and the issuer identifier. The acquirer server then transmits the approval message to a payment network server, managed by a payment network facilitator, via a switch during a trickle feed session after it is determined that the acquirer and the issuer are the same entity. The switch may also add the received approval message corresponding to the issuer to a list. The trickle feed session is one during which a plurality of approval messages are sent to the acquirer server.

In an example embodiment, the acquirer server may generate an identification message to identify the transaction after it is determined that the acquirer and the issuer are the same entity. The identification message may include an acquirer identifier identifying the acquirer. The acquirer server then transmits a plurality of identification messages to the switch, where the switch verifies data in the identification messages and data in the list based on the acquirer identifier and the issuer identifier, such that data in the list corresponds to data in the plurality of identification messages. The switch then transmits the list to the payment network server via a trickle feed session. After receiving the approval messages, the payment network server may store the transaction data in a database for reporting. For example, the payment network server may include the transaction data in a consolidated statement to be sent to the user at the end of the month.

### Terms Description (in Addition to Dictionary Meaning of Terms)

A transaction may include a financial transaction, which is an agreement, or communication, carried out between a buyer (e.g. a user or account holder) and a seller (e.g. a merchant) to exchange an asset for payment. It involves a change in the status of the finances of two or more businesses or individuals. Accordingly, transaction data refers to information that is exchanged or provided during the transaction. Examples of transaction data may include the user's account details (e.g. user's card details). The user's account details may include an issuer's identifier identifying the issuer managing the user's account. The transaction data may also include an amount of the product, a description of the product and merchant details relating to the merchant who is involved in the transaction. The transaction request may also include transaction data relating to the merchant, e.g. a merchant's account identifying an acquirer managing the merchant's account.

An acquirer refers to a bank or financial institution that processes credit or debit payments on behalf of the merchant. The acquirer may manage a corresponding acquirer server which may allow merchants to accept payments (e.g. credit cards) from the card-issuing banks. The acquiring bank may enter into a contract with the merchant and may offer the merchant a corresponding merchant account. This arrangement provides the merchant with a line of credit. Under the agreement, the acquiring bank exchanges funds with issuers (i.e. issuing banks) on behalf of the merchant, and pays the merchant for its daily payment-card activity's net balance, that is, gross sales minus reversals, interchange fees, and acquirer fees. The acquirer may impose acquirer fees for an additional cost mark-up added to an association of interchange fees and may vary according to the acquirer's discretion. The acquirer may also maintain an acquiring channel that drives a network for a payment terminal. The payment terminal may be provided by the acquirer and the network may have the capability of accepting transactions from the payment terminal connected to the acquirer's interface.

An issuer refers to a bank or credit union who offers credit means to consumers (or users), such as credit cards. The issuer makes the credit limit available to cardholders (i.e. users) and is responsible for sending payments to the acquirer or merchants for purchases made with credit cards from that bank. The issuer may manage a corresponding issuer server which interlinks the user and the acquirer by contracting with the cardholders for the terms of the repayment of transactions.

A payment terminal refers to a device in which payment for goods and/or services (or a product) can be made. In the following disclosure, the payment terminal may be a device located at the merchant's store, a portable computing device or a payment gateway in the merchant's website. Examples of such a terminal may be a point-of sale (POS) terminal, an automated teller machine, a mobile phone, a laptop or a tablet.

A payment network server is used to settle financial transactions through the transfer of monetary value, and include the institutions, instruments, people, rules, procedures, standards, and technologies that make such an exchange possible. The payment network server may be managed by a payment network facilitator which is an intermediary that links the different parties involved in a financial transaction. For example, when a user uses his credit card at the payment device to initiate a transaction request, the payment network server (or payment network facilitator) may route the transaction request from the payment terminal to the issuer and may route an approval from the issuer to the acquirer. A further example of the payment network server is one that manages rules for accounts that maybe issued by issuers and facilitates funds exchange between accounts. Therefore, the payment network server may connect the issuer associated to an account of the user and the merchant for the transfer of funds between the issuer and the merchant. The payment network server (or payment network facilitator) may also generate programming codes and instructions relating to the transaction.

A transaction log file refers to a digital file that includes log records produced during the transaction process. The transaction log file may be managed by the issuer server or the acquirer server and may include transaction data corresponding to a transaction. Examples of log records include time and date of the transaction, an issuer identity and an acquirer identity. In the following disclosure, the transaction log file may include a plurality of approval messages from the issuer to the acquirer after the product amount has been transferred from the user's account (card and/or digital wallet). In example embodiments, the issuer identity and the acquirer identity may be identical when the issuer and acquirer are the same entity, such as in an ON_US transaction.

A trickle feed refers to a process of supplying a continuous small amount of information which may allow a continuous update of data. In the following disclosure, a trickle feed and a trickle feed session relate to the process of providing the transaction log file in a significant amount. For example, the transaction log file may include fifty approval messages from the issuer to the acquirer and is transmitted to the payment network server via a trickle feed during a trickle feed process.

An ON_US transaction refers to a transaction that is acquired by the same entity, processed by the same entity processor and then approved by the same entity. An example to illustrate an ON_US transaction is as follows. The issuer of a user's account and the acquirer of the merchant's account is bank A while the credit card is one that complies with rules determined by a payment network facilitator D. In this scenario, the transaction shall be routed within bank A without transmitting the transaction data to the payment network facilitator D.

A switch refers to a networking device that connects other devices in a computer network together. The switch may enable communication between the other devices by managing the flow of data across these devices. For example, the switch may receive a data packet from one device and transmit the data packet to another device. In embodiments described below, the switch may be an intermediary entity that authorizes data and facilitates data transfer between an issuer, an acquirer and a payment network facilitator.

### EXEMPLARY EMBODIMENTS

Embodiments of the present invention will be described, by way of example only, with reference to the drawings. Like reference numerals and characters in the drawings refer to like elements or equivalents.

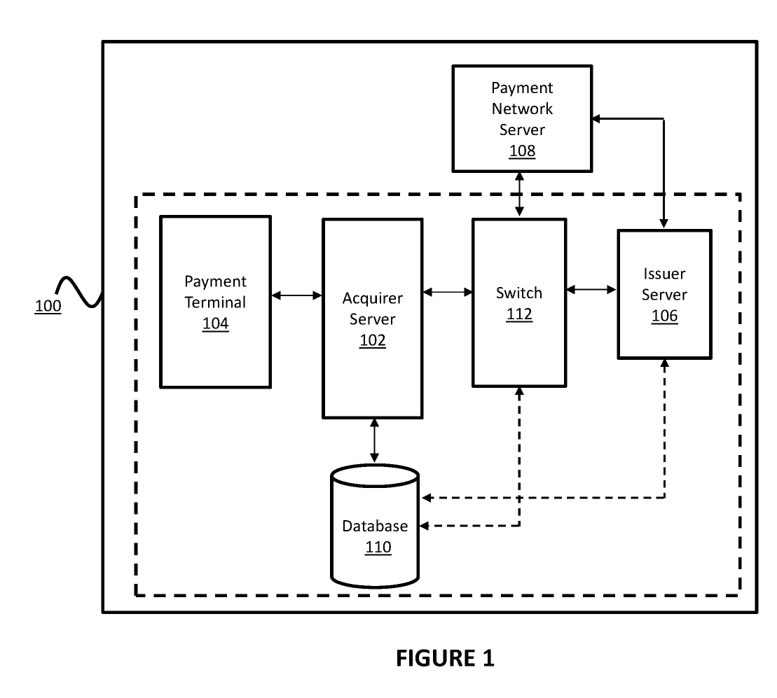

FIG. 1 illustrates a block diagram of a system 100 within which a transaction can be completed at a payment terminal. The system 100 comprises an acquirer server 102, a payment terminal 104, an issuer server 106, a payment network server 108, a database 110 and a switch 112. The acquirer server 102 is in communication with the payment terminal 104, the issuer server 106, the payment network server 108 and the database 110. The issuer server 106 is in communication with the switch 112, which is in communication with the payment network server 108.

The acquirer server 102 typically is associated with a corresponding acquirer and may include one or more computing devices that are used to perform a payment transaction (or a transaction). The acquirer may be an entity (e.g. a bank company or organization) which issues (e.g. establishes, manages, administers) a transaction credential or an account (e.g. a financial bank account) of the merchant.

The payment terminal 104 typically is associated with the acquirer and may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like. The payment terminal 104 may be capable of wireless communication using a suitable protocol with a device of the user.

The transaction may refer to a financial transaction, including a transaction request, between the user and the merchant for the purchase of a product (or goods and/or services). The transaction may thus involve the exchange of good and/or services and/or money between the user and the merchant.

The issuer server 106 generally is associated with a corresponding issuer and may include one or more computing devices that are used to perform a payment transaction. The issuer may be an entity (e.g. a bank company or organization) which issues (e.g. establishes, manages, administers) a transaction credential or an account (e.g. a financial bank account, a credit card account or a digital wallet) to the user (or consumer).

The payment network server 108 typically is associated with a payment network facilitator. For example, the payment network server 108 may be the Banknet® network operated by MasterCard®. The payment network facilitator (e.g. MasterCard®) may be an entity (e.g. a company or organization) who operates to process transactions, clear and settle funds for payments between two other entities (e.g. two banks). The payment network server 108 may include one or more computing devices that are used for processing transactions.

The database 110 may store data corresponding to a plurality of merchants and data corresponding to a transaction. Examples of the data include Transaction ID, Merchant ID, Merchant Name, Merchant Category Code/Industry Code, Industry Description, Merchant Country, Merchant Address, Merchant Postal Code, Aggregate Merchant ID and or other relevant information that is provided when the merchant opens an account with the acquirer. The database 110 may also store data relating to the user, such as the user's biological data, User ID, User Name, User Account (e.g. a credit card account or a digital wallet), User Address and Postal Code. The database 110 may also store data corresponding to a transaction such as the product description and price of the product.

The switch 112 may refer to a payment gateway which may be an intermediary entity that authorizes data and facilitates data transfer between the issuer, the acquirer and the payment network facilitator. One of the main functions of the switch 112 is to harmonize/standardize payment data formats and may serve to connect the issuer, the acquirer and the payment network facilitator. More specifically, the transaction is routed to the switch 112 or payment gateway, which then determines and provides routing of the transaction. The switch 112 may, at the background, maintain connections to each of the different servers as well as maintaining direct connections to different issuers such as Bank of America® or Citibank®. For example, a transaction may be initiated at a POS terminal managed by bank G (i.e. acquirer) in a pharmacy in United States by a user having a credit card issued by bank A (i.e. issuer) in Colombia. The switch 112 may determine a probable routing path from bank G to a switch provider in US, which then routes to payment network facilitator D and thereon to bank A in Colombia. The response from the bank A to bank G would be in the reverse direction.

During a transaction, a transaction request is generated at the payment terminal 104. The payment terminal 104 may be located at the merchant store and managed by an acquirer having a corresponding acquirer server 102. In other words, the payment terminal 104 and the acquirer server 102 are managed by the same entity. In an alternative embodiment, the payment terminal 104 may be managed by a different entity, such as VeriFone® or Ingenico®, which is not an acquirer but is connected to a network of the acquirer. The transaction request may include transaction data including account details identifying an account and an issuer managing the account. The account may be a credit card account or a digital wallet belonging to the user who initiates the transaction request at the payment terminal 104. The transaction data may also include a product in which the user is interested, a product amount of the product and a description of the product.

In an implementation, the transaction request may be initiated at a retail shop of the merchant and the payment terminal 104 may correspond to the POS terminal of the merchant. In specific implementations, the payment terminal 104 may be fitted with a wireless communications interface such as a Near Field Communication (NFC) interface to enable electronic communication with a user payment device, such as a mobile phone, to perform the transaction. The user payment device may be a device on which the user pays for his purchase and may include a tablet, a credit card or a laptop. NFC is a set of standards to establish radio communication between devices by bringing them into close proximity such as only a few centimetres. NFC standards cover communication protocols and data exchange formats, and are based on radio-frequency identification (RFID) technology.

In an example, David (or a user) has a credit card issued by bank A (or an issuer). David buys a bicycle worth $300 from merchant X and initiates the transaction request to purchase the bicycle at the POS terminal of merchant X using his credit card. Alternatively, David may pay for his purchase using a virtual wallet that is linked to his credit card, such as MasterPass®, that is installed in his mobile phone. During checkout, David places his mobile phone near the POS terminal of X to initiate the transaction. The POS terminal may be managed by bank G (or an acquirer) with which merchant X has an account. As David's credit card is used, details of David's credit card identifying bank A are transmitted to bank G's server. In addition, product information such as a ten-speed mountain bicycle by manufacturer Y and the cost of $300 for the bicycle may also be transmitted to bank G server.

In an alternative embodiment, the payment terminal 104 may be a web portal where the user may initiate the transaction request. In this case, the user searches for products on a merchant's website and purchases a product. He enters the details of his credit card during checkout and the information is transmitted to the acquirer server 102. Therefore, the transaction is carried out remotely through the website.

The acquirer server 102 determines if the issuer corresponds to the same entity in response to the receipt of the transaction data. Such a transaction is an ON_US transaction if it is determined that the issuer is the same entity. The acquirer server 102 forwards the transaction request to the issuer server 106 for approval. When the issuer server 106 receives the transaction request, it may determine whether there are sufficient funds in the user's account based on the user's account details and product amount. If there are sufficient funds, the issuer server 106 debits the product amount from the user account and transmits an approval message to the acquirer server 102. In an implementation, the issuer server 106 may forward a notification message to a user device informing the user who is purchasing the product that the product amount has been debited. The issuer server 106 may also allocate a corresponding reward (e.g., loyalty points) to the user after the transaction is approved by the issuer server 106. The acquirer server 102 then forwards, to a payment network server 108, the approval message that is received from the issuer server 106 corresponding to the issuer when it is determined that the issuer corresponds to the same entity. The approval message may be transmitted to the payment network server 108 via a switch 112 located between the acquirer server 102 and the issuer server 106.

In embodiments, the acquirer server 102 may generate an identification message identifying the transaction when it is determined that the issuer corresponds to the same entity managing the acquirer server 102 and the payment terminal 104. The acquirer server 102 may also include an acquirer identifier in the transaction data to identify the acquirer. The acquirer server 102 then transmits the identification message to the switch 112, which causes the switch 112 to include an indicator to the approval message after the switch 112 receives the approval message from the issuer server 106. In other words, the acquirer server 102 controls the switch 112 to include the indicator in the approval message. The indicator in the approval message may indicate that the approval message relates to a transaction to the issuer being the same entity managing the acquirer server 102 and the payment terminal 104. The acquirer server 102 may aggregate a plurality of identification messages and store as a transaction log file in the database 110. The transaction log file may also include transaction data that is transmitted during the transaction request.

With reference to the earlier example, bank G (or an acquirer) forwards the transaction request for purchasing the bicycle to bank A (or an issuer) for approval. Bank A determines that David (or a user) has sufficient funds to pay for the $300 bicycle and credits $300 from David's account (or credit card). Subsequently, bank A approves the transaction and sends the approval message to bank G. After the transfer of funds from David's account to the merchant X account, bank G also determines whether the issuer of the credit card is also the same entity. In other words, bank G's server determines whether bank G and bank A are identical banks. Once it determines that bank G and bank A are identical (i.e. an ON_US transaction), bank G server forwards the approval message to a switch Z.

The acquirer server 102 receives the approval message from the issuer server 106 corresponding to the issuer. The approval message may include an issuer identifier identifying the issuer. The acquirer server 102 then forwards the approval message to the switch 112, which may then add the approval message corresponding to the issuer to a list, which lists the approval message corresponding to the issuer who has generated the approval message. The switch 112 may also receive a plurality of identification messages from the acquirer server 102. Each of the plurality of identification messages may include the corresponding acquirer identifier identifying the acquirer. The switch 112 then verifies data in the list and data in the in the plurality of identification messages based on the acquirer identifier and the issuer identifier, such that the data in the list corresponds to the data in the plurality of identification messages. The switch 112 may include a trickle feed generator which generates a plurality of data packets and also generates a request message to the payment network server 108 for transmitting the approval message via a trickle feed session. The request message may be one which the switch 112 requests the payment network server 108 for the transfer of the plurality of identification messages using the plurality of data packets via trickle feed session. The request message may also serve to inform the payment network server 108 the availability of transaction data for ON_US transactions. The switch 112 may also transmit the list to the payment network server 108 via the trickle feed session after a successful verification of the data in the list and the data in the plurality of identification messages. It can be appreciated that a list request message may be generated by the switch 112 to the payment network server 108 when the switch 112 transmits the list.

The trickle feed session may be one during which the switch 112 sends the approval message or the list continuously to the payment network server 108 in small packets of data. Alternatively, the switch 112 may also send the approval message or the list to the payment network server 108 during the predetermined period of time or at a predetermined time, i.e. every 2 hours or 5 pm daily. In other words, the trickle feed session may be one during which the switch 112 provides the plurality of data packets to the payment network server 108 during a time period. In this way, the data may be sent discreetly in the background without using large bandwidth for transmission. Advantageously, the small size of the data packets may ensure that the data can be transmitted quickly and continuously to the payment network server 108 when required. After receiving the approval message or the list, the payment network server 108 may then transmit an acknowledgement message, or a list acknowledgement message, back to the switch 112 indicating a successful transmission of the approval message or the list. Thus, the switch 112 may identify the specific lists and approval messages that have been successfully transmitted to the payment network server 108 to avoid sending duplicate copies of lists and approval messages. The switch 112 may also aggregate a plurality of request messages, a plurality of lists and a plurality of acknowledgement messages and store them as a transaction log file into the database 110. The stored transaction log file may be used for record keeping purposes such that the switch 112 may easily retrieve past request messages, lists and acknowledgement messages relating to historical transactions when required.

After the switch 112 receives the acknowledgement message (or the list acknowledgement message) from the payment network server 108, it forwards the acknowledgement message to the acquirer server 102. The switch 112 may be controlled by the acquirer server 102 such that it transmits the acknowledgement message upon receiving from the payment network server 108. The acquirer server 102 then generates a transaction completion message in response to the acknowledgement message. Alternatively, the transmission completion message may be generated in response to a successful transfer of funds to an acquirer account included in the transaction data. The transaction completion message may then be forwarded to the payment terminal 104 to indicate that the transaction has been completed.

As mentioned above, the role of the switch 112 is to facilitate communication between the acquirer server 102, the issuer server 106 and/or the payment network server 108. In specific implementations, the acquirer server 102 may be further configured to perform additional operations. For example, the acquirer server 102 may be configured to update the database 110 whenever the merchant registers for an account.

Additionally, the issuer server 106 may also be configured to calculate a reliability score for each user based on the historical transactions (including repayment of loans) relating to the user. The historical transactions may be a ledger or a record of transactions that have been carried out using the account. In an implementation, the acquirer server 102 may be part of the issuer server 106 and managed by the acquirer. In another implementation, the switch 112 may be part of the issuer server 106 and administered by the issuer.

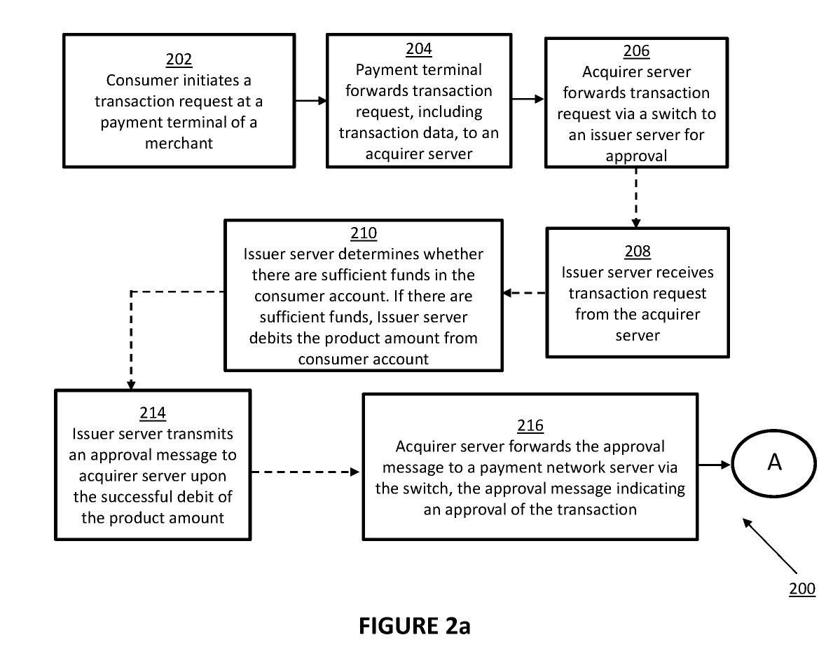

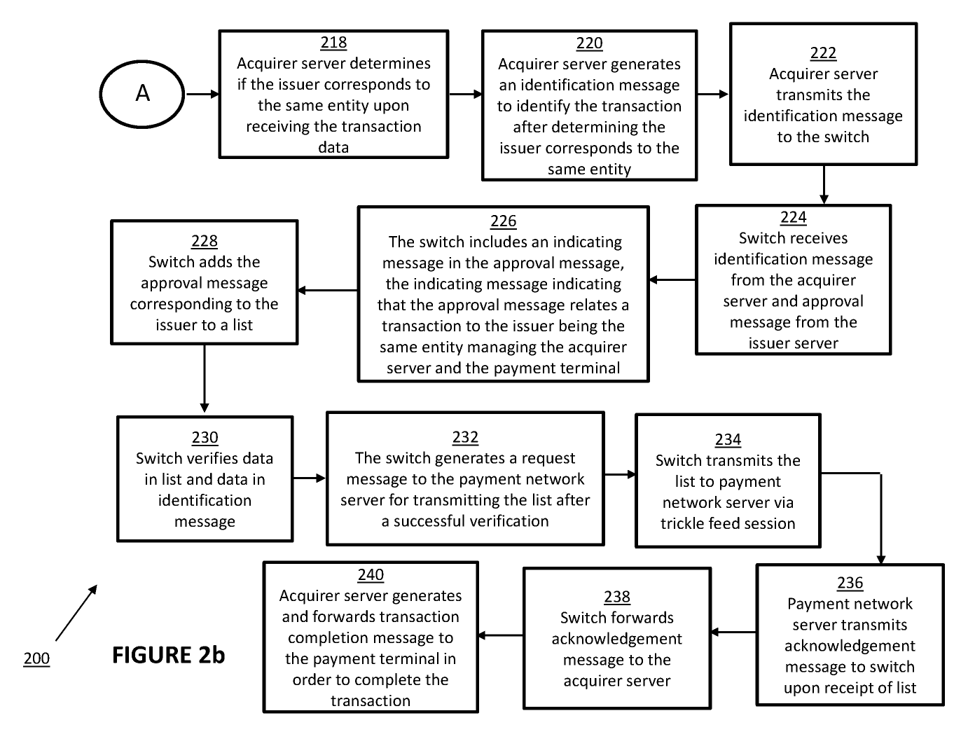

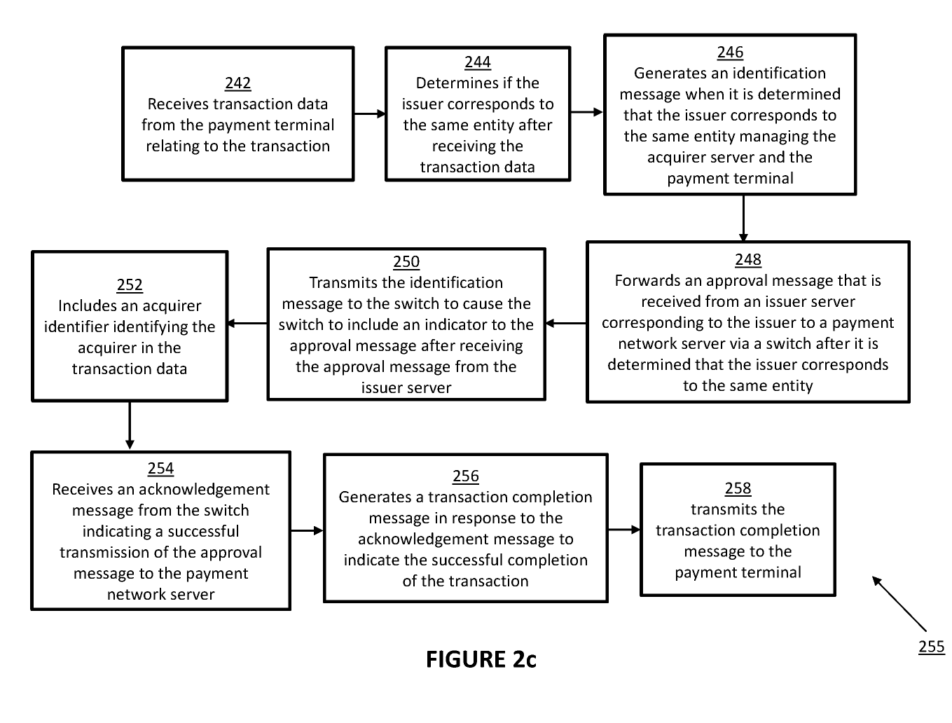

Such a server may be used to implement the method 200 shown in FIGS. 2a to 2b. FIGS. 2a to 2b show a flowchart 200 illustrating the flow of information during a method for completing a transaction initiated at a payment terminal, according to an example embodiment. More particularly, FIG. 2a shows the flow of information from an overview perspective while FIG. 2b shows the flow of information in a detailed perspective after it is determined that the acquirer and the issuer are the same entity.

As shown in FIG. 2a, a user initiates a transaction request at a payment terminal of a merchant at step 202. The payment terminal may be administered by an acquirer with which the merchant may have an account. The user may also initiate the transaction request remotely from an application program that is installed and executed on the merchant's website. Alternatively, the application program may also be installed and executed on a communication device associated with the user, such as a mobile telephone or a laptop. At step 204, the payment terminal forwards the transaction request, including transaction data, to an acquirer server which is administered by the acquirer. The transaction data may include an acquirer identifier identifying the acquirer and an issuer identifier identifying an issuer which the user has an account with. At step 206, the acquirer server forwards the transaction request via a switch to an issuer server, which may be administered by the issuer, for approval. At step 208, the issuer server receives the transaction request from the acquirer server. At step 210, the issuer server determines whether there are sufficient funds in the user's account. If there are sufficient funds, the issuer server debits a product amount from the user's account. At step 214, the issuer server transmits an approval message to the acquirer server upon the successful debit of the product amount. At step 216, the acquirer server forwards the approval message to payment network server via the switch, the approval message indicating an approval of the transaction.

Continuing from FIG. 2a, at step 218 in FIG. 2b, the acquirer server determines if the issuer corresponds to the same entity upon receiving the transaction data. The acquirer server may do so by comparing the issuer identifier and the acquirer identifier that are included in the transaction data. At step 220, the acquirer server generates an identification message to identify the transaction after determining the issuer corresponds to the same entity. At step 222, the acquirer server transmits the identification message to the switch. At step 224, the switch receives the identification message from the acquirer server and the approval message from the issuer server. At step 226, the switch includes an indicating message in the approval message, the indicating message indicating that the approval message relates a transaction to the issuer being the same entity managing the acquirer server and the payment terminal. At step 228, the switch adds the approval message corresponding to the issuer to a list.

FIG. 2c shows a flow chart 255 illustrating the flow of information from an acquirer server perspective during a method for completing a transaction initiated at a payment terminal according to an example embodiment. At step 242, the acquirer server 102 receives transaction data from the payment terminal 104 relating to the transaction. The transaction data may include account details identifying an account and an issuer managing the account. At step 244, the acquirer server 102 determines if the issuer corresponds to the same entity after receiving the transaction data. At step 246, the acquirer server 102 generates an identification message when it is determined that the issuer corresponds to the same entity managing the acquirer server 102 and the payment terminal 104. At step 248, after it is determined that the issuer corresponds to the same entity, the acquirer server 102 forwards an approval message that is received from an issuer server 106 corresponding to the issuer to a payment network server 108 via a switch 112. The approval message may be one that approves the transaction while the identification message may be one that identifies the transaction. At step 250, the acquirer server 102 transmits the identification message to the switch 112 to cause the switch 112 to include an indicator to the approval message after receiving the approval message from the issuer server 106. The indicator included by the switch 112 may indicate that the approval message relates a transaction to the issuer being the same entity managing the acquirer server 102 and the payment terminal 104. In an embodiment, the acquirer server 102 may control the switch 112 to include the indicator to the approval message. At step 252, the acquirer server 102 includes an acquirer identifier identifying the acquirer in the transaction data. At step 254, the acquirer server 102 receives an acknowledgement message from the switch 112 indicating a successful transmission of the approval message to the payment network server 108. In an embodiment, the acquirer server 102 may control the switch to transmit the acknowledgement message. At step 256, the acquirer server 102 generates a transaction completion message in response to the acknowledgement message to indicate the successful completion of the transaction. The transmission completion message may be generated in response to a successful transfer of funds to an acquirer account included in the transaction data. At step 258, the acquirer server 102 transmits the transaction completion message to the payment terminal 104.

At step 230, the switch verifies data in list and data in identification message. At step 232, the switch generates a request message to the payment network server for transmitting the list after a successful verification. The request message may serve as a notification to the payment network server on the presence and availability of data for transactions in which the issuer and the acquirer are the same entity (i.e. ON_US transactions). At step 234, the switch transmits the list to the payment network server via a trickle feed session. The trickle feed session may be generated by a tickle feed generator that is part of the switch. At step 236, the payment network server transmits an acknowledgement message to the switch upon receipt of the list. At step 238, the switch forwards the acknowledgement message to the acquirer server. At step 240, the acquirer server generates and forwards a transaction completion message to the payment terminal in order to complete the transaction.

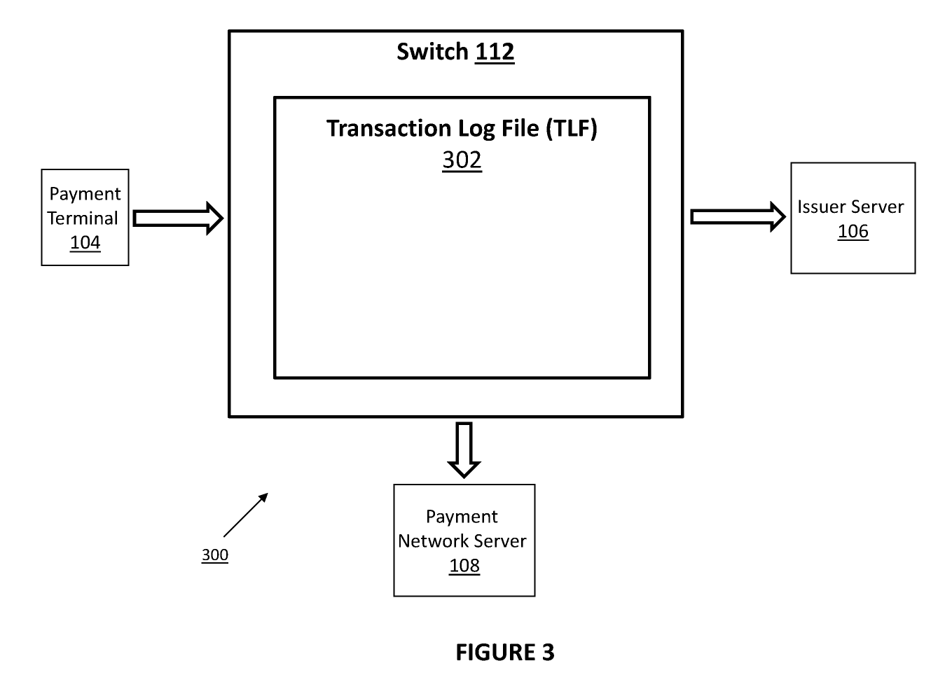

FIG. 3 shows a schematic diagram 300 illustrating the flow of information between various entities during a method for completing a transaction initiated at a payment terminal, according to an example embodiment. In this embodiment, a transaction request may be initiated at the payment terminal 104, such as a wireless POS terminal. The payment terminal 104 may be administered by an acquirer, e.g. bank G. The transaction request may include transaction data which is transmitted to a switch 112. The switch 112 in this case is also managed by the same entity as the acquirer, i.e. bank G. The switch 112 may maintain a transaction log file (TLF) 302 upon receiving a plurality of transaction requests from the payment terminal via the acquirer server 102. The switch 112 then forwards the transaction request to the issuer server 106 for approval of the transaction request. The issuer server 106 may be the same entity, i.e. bank G. The switch 112 may update the transaction log file 302 when it receives an approval message from the issuer server 106 approving the transaction. Thereafter, the switch 112 transmits the transaction log file 302 to the payment network server 108 as shown in FIG. 3.

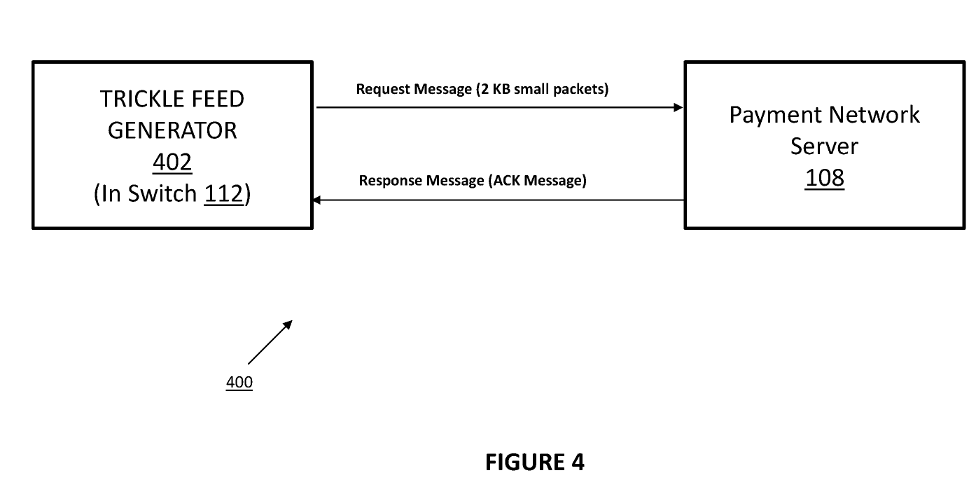

FIG. 4 shows a schematic diagram 400 illustrating the flow of information between a trickle feed generator 402 and a payment network server 108 during a method for completing a transaction initiated at a payment terminal, according to an example embodiment. In this embodiment, the trickle feed generator 402 is part of the switch 112 and transmits a request message to the payment network server 108. The request message may include an approval message from the issuer server and may in small packets of about 2 kilobytes (2 KB). Upon the successful receipt of the approval message, the payment network server 108 sends a response message or an acknowledgement message to the trickle feed generator 402 indicating that the approval message is received.

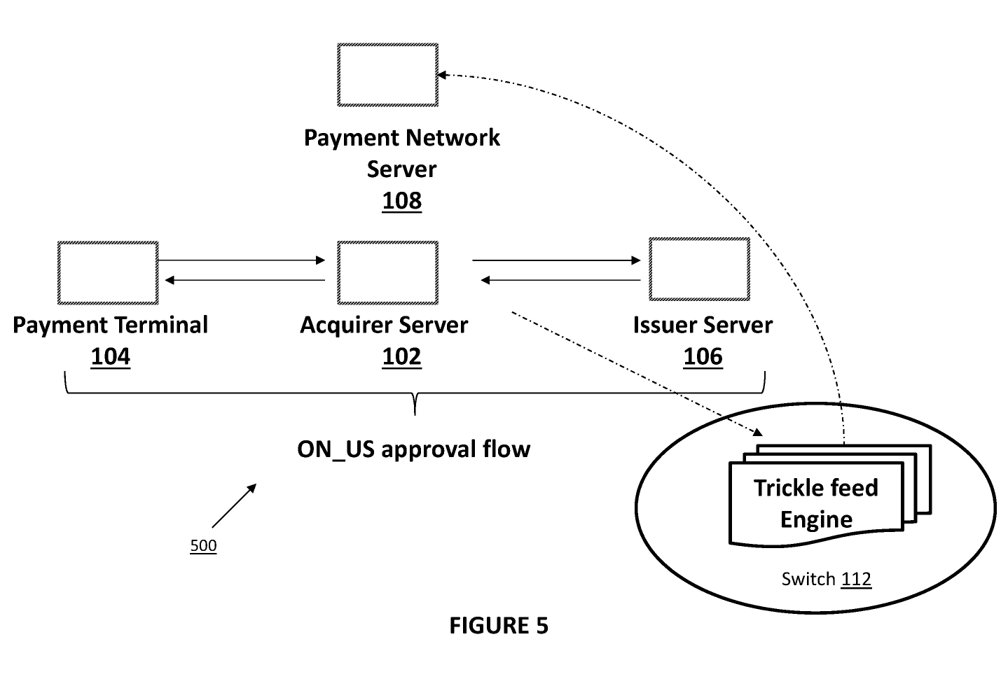

FIG. 5 shows a schematic diagram 500 illustrating the flow of information between various entities during a method for completing a transaction initiated at a payment terminal, according to an example embodiment. In this embodiment, payment terminal 104 receives a transaction request and transmits to the acquirer server 102. The acquirer server 102 may be one that is managed by an acquirer. The acquirer server 102 then transmits the transaction request to issuer server 106. Issuer server 106 then transmits the approval message to the acquirer server 102 upon the successful approval of the transaction. The acquirer server 102 then sends the approval message to payment terminal 104. The process previously described constitutes a typical ON_US approval flow if the payment terminal 104, the acquirer server 102 and the issuer server 106 are the same entity. In addition, the acquirer server 102 forwards the approval message to a trickle feed engine if it determines the payment terminal 104, the acquirer server 102 and the issuer server 106 are the same entity. The trickle feed engine may be part of a switch 112. Subsequently, the trickle feed engine forwards the approval message to payment network server 108 via trickle feed at regular intervals.

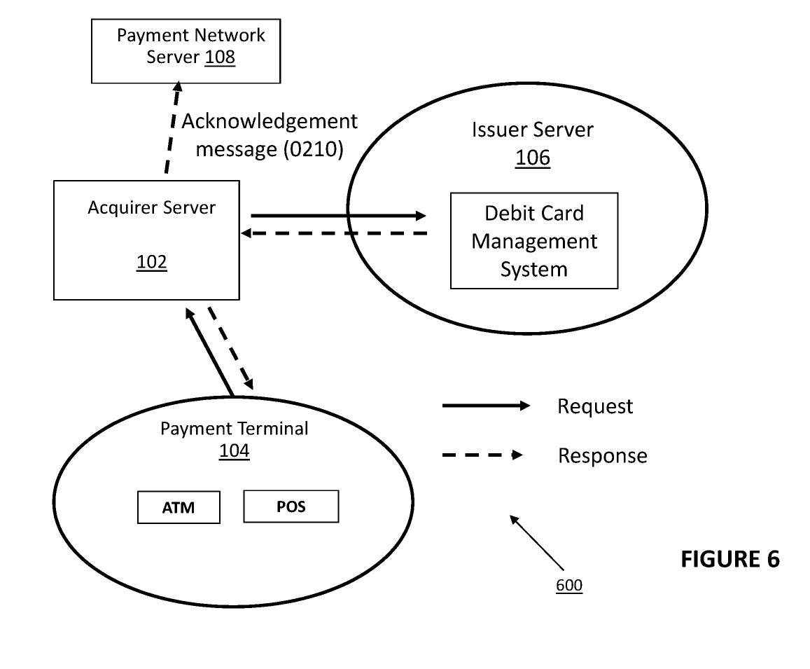

FIG. 6 shows a schematic diagram 600 illustrating the transaction request and response between various entities during a method for completing a transaction initiated at a payment terminal, according to an example embodiment. In this embodiment, the transaction request may be initiated at the payment terminal 104, such as a wireless POS terminal or at an automated teller machine (ATM). The payment terminal 104 may be administered by an entity such as a bank. The payment terminal 104 sends the transaction request to an acquirer server 102 which may be managed by an acquirer. The acquirer server 102 then sends the transaction request to a debit card management system of an issuer server 106 for approval. If the transaction request is approved, the issuer server 106 sends the approval message to the acquirer server 102. The acquirer server 102 then responds to the transaction request by sending the approval message to the payment terminal 104. Thereafter, the acquirer server 102 transmits an acknowledgement message to the payment network server 108.

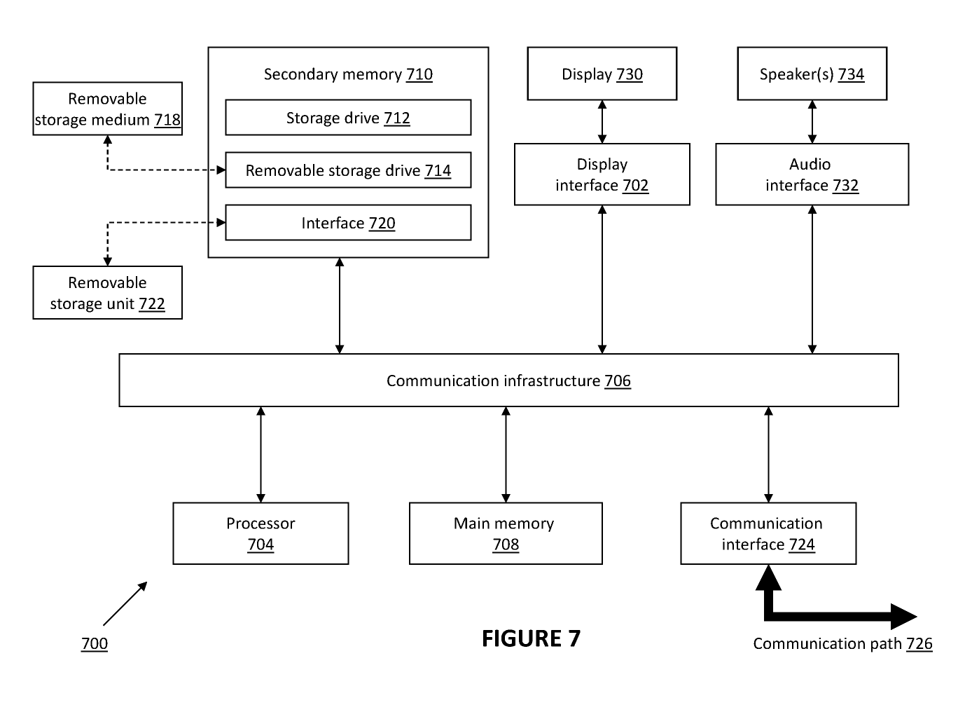

FIG. 7 depicts an exemplary computer/computing device 700, hereinafter interchangeably referred to as a computer system 700, where one or more such computing devices 700 may be used to facilitate execution of the above-described method. In addition, one or more components of the computer system 700 may be used to realize the acquirer server 102, issuer server 106, payment network server 108 or switch 112. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage medium 718 in a well-known manner. The removable storage medium 718 may include magnetic tape, optical disk, non-volatile memory storage medium, or the like, which is read by and written to by removable storage drive 714. As will be appreciated by persons skilled in the relevant art(s), the removable storage medium 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 720. Examples of a removable storage unit 722 and interface 720 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 720 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments of the inventions, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port (such as a serial, parallel, printer, GPIB, IEEE 1394, RJ25, USB), an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage medium 718, removable storage unit 722, a hard disk installed in storage drive 712, or a carrier wave carrying software over communication path 726 (wireless link or cable) to communication interface 724. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the storage drive 712, or the interface 720. Alternatively, the computer program product may be downloaded to the computer system 700 over the communications path 726. The software, when executed by the processor 704, causes the computing device 700 to perform functions of embodiments described herein. For example, the method of FIGS. 2a to 2b may be implemented as software and stored in a non-transitory fashion in the secondary memory 710 or the removable storage units 718, 722 of the computer device 700.

It is to be understood that the embodiment of FIG. 7 is presented merely by way of example. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

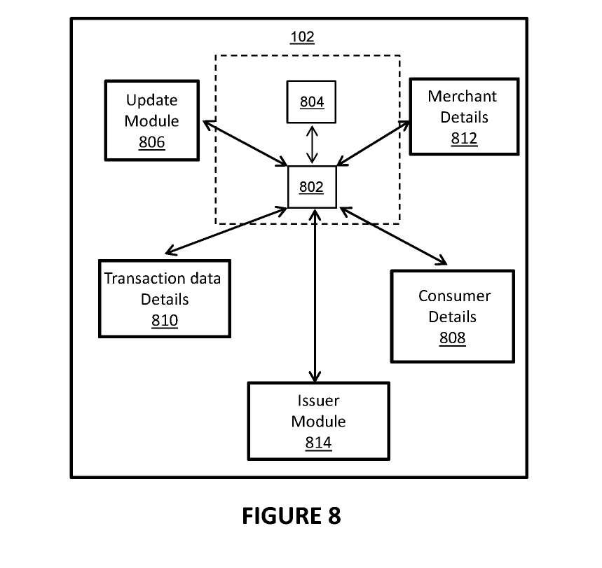

In an implementation, the acquirer server 102 may be generally described as a physical device comprising at least one processor 802 and at least one memory 804 including computer program code. The at least one memory 804 and the computer program code are configured to, with the at least one processor 802, cause the physical device to perform the operations described in FIGS. 2a to 2b. An example of the acquirer server 102 is shown in FIG. 8. The acquirer server 102 shown in FIG. 8 may also include an update module 806, a consumer details module 808, a transaction data details module 810, a merchant details module 812 and an issuer module 814. The memory 804 stores computer program code that the processor 802 compiles to have each of the update module 806, the user details module 808, the transaction data details module 810, the merchant details module 812 and the issuer module 814 perform their respective functions. With reference to FIG. 1, the update module 806 is configured to update the database 110 on the status of the transaction, transaction data, product amount, description of the product details of the merchant and details of the user and the issuer. The user details module 808 is configured to receive information relating to the user. The transaction data details module 810 is configured to receive details of the transaction while the merchant details module 812 is configured to receive details of the merchant. The issuer module 814 is configured to receive details of the issuer.

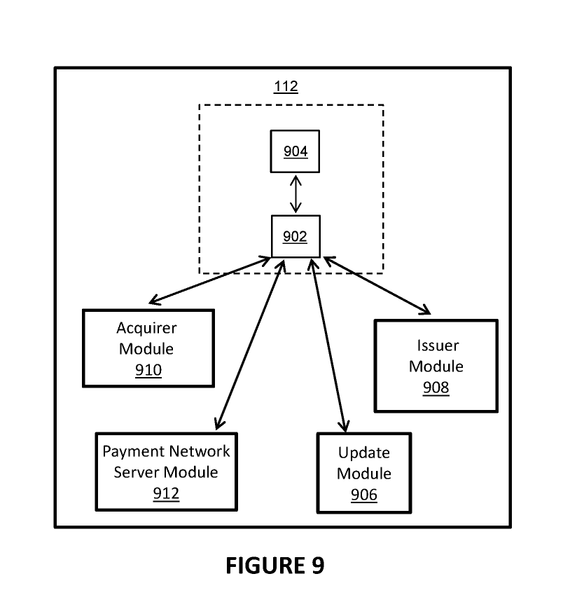

In an implementation, the switch 112 may be generally described as a physical device comprising at least one processor 902 and at least one memory 904 including computer program code. The at least one memory 904 and the computer program code are configured to, with the at least one processor 902, cause the physical device to perform the operations described in FIGS. 2a to 2b. An example of the switch 112 is shown in FIG. 9. The switch 112 shown in FIG. 9 may also include an update module 906, an issuer module 908, an acquirer module 910 and a payment network module 912. The memory 904 stores computer program code that the processor 902 compiles to have each of the update module 906, the issuer module 908, the acquirer module 910 and the payment network module 912 perform their respective functions. With reference to FIG. 1, the update module 906 is configured to update the database 110 on the status of the transaction, an approval message including an indicator to indicate that the approval message relates to a transaction to the issuer being the same entity managing the acquirer server and the payment terminal, an acknowledgement message, a list listing the approval message and a request message. The issuer module 908 is configured to receive the approval message from the issuer while the acquirer module 910 is configured to receive transaction data and to transmit the acknowledgement message to the acquirer server 102. The payment network module 912 is configured to transmit the approval message including the indicator, the list listing the approval message and the request message for transmitting the approval message during a trickle feed session.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analysing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses server for performing the operations of the methods. Such server may be specially constructed for the required purposes, or may comprise a computer or other device selectively activated or reconfigured by a computer program stored in the computer. The algorithms and displays presented herein are not inherently related to any particular computer or other server. Various machines may be used with programs in accordance with the teachings herein. Alternatively, the construction of more specialized server to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in a server that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed is:

1. A system, comprising an acquirer server and a payment terminal, for completing a transaction initiated at the payment terminal, the acquirer server and the payment terminal being managed by a same entity, the acquirer server comprising:
at least one processor; and
at least one memory including computer program code;
the at least one memory and the computer program code configured to, with the at least one processor, cause the acquirer server at least to:
receive, from the payment terminal, transaction data relating to the transaction, the transaction data including account details identifying an account and an issuer managing the account;
determine if the issuer corresponds to the same entity in response to the receipt of the transaction data; and
forward, to a payment network server, an approval message that is received from an issuer server corresponding to the issuer when it is determined that the issuer corresponds to the same entity, the approval message approving the transaction.

2. The system according to claim 1, wherein the approval message is forwarded to the payment network server via a switch that is located between the acquirer server and the issuer server, wherein the acquirer server forwards the approval message to the payment network server via the switch, and wherein the at least one memory and the computer program code is further configured with the at least one processor, cause the acquirer server at least to:
generate an identification message when it is determined that the issuer corresponds to the same entity managing the acquirer server and the payment terminal, the identification message identifying the transaction;
include, in the transaction data, an acquirer identifier identifying the acquirer; and
transmit, to the switch, the identification message to cause the switch to include an indicator to the approval message after receiving the approval message from the issuer server, the indicator indicating that the approval message relates a transaction to the issuer being the same entity managing the acquirer server and the payment terminal.

3. The system according to claim 2, wherein the at least one memory and the computer program code is further configured with the at least one processor, cause the acquirer server at least to:
receive, from the switch, an acknowledgement message indicating a successful transmission of the approval message to the payment network server;
generate a transaction completion message in response to the acknowledgement message to indicate the successful completion of the transaction, the transmission completion message being generated in response to a successful transfer of funds to an acquirer account included in the transaction data; and
transmit, to the payment terminal, the transaction completion message.

4. The system according to claim 2, wherein the at least one memory and the computer program code is further configured with the at least one processor, cause the acquirer server at least to:
control the switch to include the indicator to the approval message.

5. The system according to claim 3, wherein the at least one memory and the computer program code is further configured with the at least one processor, cause the acquirer server at least to:
control the switch to transmit the acknowledgement message.

6. A device for completing a transaction initiated at the payment terminal, the device comprising:
at least one processor; and
at least one memory including computer program code;
the at least one memory and the computer program code is further configured with the at least one processor, cause the device at least to:
receive, from an issuer server, an approval message corresponding to an issuer;
include an indicator in the approval message, the indicator indicating that the approval message relates to a transaction to the issuer being the same entity managing an acquirer server and a payment terminal; and
add the approval message corresponding to the issuer to a list, the list listing the approval message corresponding to the issuer who has generated the approval message.

7. The device according to claim 6, wherein the at least one memory and the computer program code is further configured with the at least one processor, cause the device at least to:
generate a plurality of data packets; and
generate and transmit a request message to a payment network server for transmitting the approval message during a trickle feed session, the trickle feed session being a time period during which the device provides the plurality of data packets to the payment network server.

8. The device according to claim 6, wherein the at least one memory and the computer program code is further configured with the at least one processor, cause the device at least to:
receive, from the payment network server, an acknowledgement message indicating a successful transmission of the approval message; and
forward, to an acquirer server, the acknowledgement message, the acquirer server corresponding to an acquirer.

9. The device according to claim 6, wherein the approval message comprises an issuer identifier identifying the issuer, the at least one memory and the computer program code is further configured with the at least one processor, cause the device at least to:
receive, from the acquirer server, a plurality of identification messages, each of the plurality of identification message comprising a corresponding acquirer identifier identifying the acquirer;
verify data in the list and data in the plurality of identification messages based on the acquirer identifier and the issuer identifier, such that the data in the list corresponds to the data in the plurality of identification messages;
transmit, to the payment network server, the list via the trickle feed session at a predetermined period of time after a successful verification of the data in the list and the data in the plurality of identification messages.

10. The device according to claim 5, wherein the at least one memory and the computer program code is further configured with the at least one processor, cause the device to:
generate and transmit a list request message to the payment network server for transmitting the list;
receive, from the payment network server, a list acknowledgement message indicating a successful transmission of the list.

11. A computer-implemented method for completing a transaction initiated at a payment terminal, the acquirer server and the payment terminal being managed by a same entity, the method comprising:
receiving, from the payment terminal, transaction data relating to the transaction, the transaction data including account details identifying an account and an issuer managing the account;
determining if the issuer corresponds to the same entity in response to the receipt of the transaction data; and
forwarding, to a payment network server, an approval message that is received from an issuer server corresponding to the issuer when it is determined that the issuer corresponds to the same entity, the approval message approving the transaction.

12. The method according to claim 11, further comprising:
generating an identification message when it is determined that the issuer corresponds to the same entity managing the acquirer server and the payment terminal, the identification message identifying the transaction;
including, in the transaction data, an acquirer identifier identifying the acquirer; and
transmitting, to the switch, the identification message to cause the switch to include an indicator to the approval message after receiving the approval message from the issuer server, the indicator indicating that the approval message relates a transaction to the issuer being the same entity managing the acquirer server and the payment terminal.

13. The method according to claim 12, the method further comprising:
receiving, from the switch, an acknowledgement message indicating a successful transmission of the approval message to the payment network server;
generating a transaction completion message in response to the acknowledgement message to indicate the successful completion of the transaction, the transmission completion message being generated in response to a successful transfer of funds to an acquirer account included in the transaction data; and
transmitting, to the payment terminal, the transaction completion message.

14. The method according to claim 12, the method further comprising:
controlling the switch to include the indicator to the approval message.

15. The method according to claim 13, the method further comprising:
controlling the switch to transmit the acknowledgement message.

16. The method according to claim 12, the method further comprising:
receiving, from the issuer server, the approval message corresponding to the issuer;
including the indicator in the approval message, the indicator indicating that the approval message relates a transaction to the issuer being the same entity managing the acquirer server and the payment terminal; and
adding, to a list, the approval message corresponding to the issuer, the list listing the approval message corresponding to the issuer who has generated the approval message.

17. The method according to claim 16, the method further comprising:
generating a plurality of data packets; and
generating and transmitting a request message to the payment network server for transmitting the approval message during a trickle feed session, the trickle feed session being a time period during which a device provides the plurality of data packets to the payment network server.

18. The method according to claim 16, the method further comprising:
receiving, from the payment network server, an acknowledgement message indicating a successful transmission of the approval message; and
forwarding, to the acquirer server, the acknowledgement message.

19. The method according to claim 17, the method further comprising:
receiving a plurality of identification messages from the acquirer server, each of the plurality of identification message comprising a corresponding acquirer identifier identifying the acquirer;
verifying data in the list and data in the plurality of identification messages based on the acquirer identifier and the issuer identifier, such that the data in the list corresponds to the data in the plurality of identification messages;
transmitting, to the payment network server, the list via the trickle feed session at a predetermined period of time after a successful verification of the data in the list and the data in the plurality of identification messages.

20. The method according to claim 16, the method further comprising:
generating and transmitting a list request message to the payment network server for transmitting the list;
receiving, from the payment network server, a list acknowledgement message indicating a successful transmission of the list.
